(19) United States
(12) Patent Application Publication
(10) Pub. No.: US 2014/0039826 A1
(43) Pub. Date: Feb. 6, 2014

(54) Measurement System Results Queue For Improved Performance

(71) Applicants: Gerardo Orozco Valdes, Austin, TX (US); Michael J. Lyons, Pflugerville, TX (US); Norman J. Kirchner, JR., Austin, TX (US); Craig E. Rupp, Ames, IA (US)

(72) Inventors: Gerardo Orozco Valdes, Austin, TX (US); Michael J. Lyons, Pflugerville, TX (US); Norman J. Kirchner, JR., Austin, TX (US); Craig E. Rupp, Ames, IA (US)

(21) Appl. No.: 13/566,860

(22) Filed: Aug. 3, 2012

(51) Int. Cl. G06F 15/00

(52) U.S. Cl. 702/123

(57) ABSTRACT

System and method for testing units under test (UUTs). A test sequence is provided that includes an acquisition sequence and a processing sequence. The acquisition sequence may include a sequence of acquisition functions for performing acquisitions on one or more UUTs. The processing sequence may include a sequence of processing functions for processing measurement data resulting from the acquisitions. Each acquisition function may be performed, including performing a plurality of acquisitions, thereby generating respective measurement data sets, and storing the respective measurement data sets in order of the acquisitions. Each processing function may be performed, including retrieving and processing each respective measurement data set in order of acquisition. At least one processing function of the processing sequence may be performed concurrently with at least one acquisition function of the acquisition sequence.

### FIELD OF INVENTION

The present invention relates to the field of radio frequency testing.

### DESCRIPTION OF THE RELATED ART

To ensure reliable performance of a product, quality control has become a major part of manufacturing. Therefore, each unit manufactured is tested under a number of conditions to ensure quality. Each test may require a number of instruments to perform a number of measurements and based on the outcome of these measurements, a decision is made to mark the unit as pass or fail. Hence, manufacturing testing plays an important role in ensuring quality products in the marketplace. Additionally, the cost of running quality control tests in a manufacturing environment directly relates to the cost of products in the market place and a manufacturer's profit. The cost of testing can be further magnified in large quantity production facilities where each unit must pass a quality control test. In such instances, the most significant cost of running the quality control test is the time it takes to run each test.

In the radio frequency (RF) domain, these quality control measurements are complex and can take a substantial amount of time. The measurements are generally taken by a signal analyzer (SA) which performs the testing in one of two ways. The first method, for which a timeline 200 is illustrated in FIG. 1A, is often referred to as a synchronous method. For a typical RF test plan, as detailed below in Table 1, RF measurements are taken sequentially, with Tc_1-Tc_4 (corresponding to configurations c_1-c_4 in Table 1) representing the time required to configure the SA and Ta_1-Ta_4 (corresponding to acquisitions a_1 to a_4 of Table 1) representing the time required to acquire each particular acquisition, RF measurements RF_Meas_1-RF_Meas_3, and non-RF measurement nRF_Meas_4. FIG. 1B is illustrative of an alternative method, referred to as an asynchronous method as illustrated by timeline 210. In FIG. 1B, the non-RF measurement, nRF_Meas_4 is initiated concurrently with RF_Meas_3, thus shortening the test time.

TABLE 1
Typical RF Test Plan

| | | Config- | Acqui- | | |
|---|---|---|---|---|---|
| | Test Name | uration | sition | Low Limit | High Limit |
| 1 | RF_Meas_1 | c_1 | a_1 | r_low_1 | r_high_1 |
| 2 | RF_Meas_2 | c_2 | a_2 | r_low_2 | r_high_2 |
| 3 | RF_Meas_3 | c_3 | a_3 | r_low_3 | r_high_3 |
| 4 | nRF_Meas_4 | c_4 | a_4 | r_low_4 | r_high_4 |

c: configuration, a: acquisition, r_low: low limit for result, r_high: high limit for result

FIG. 2A illustrates a third component of an RF measurement, the processing time, Tp_1-Tp_4, as illustrated by timeline 220. Following the four measurement example above, for a test plan using a synchronous method of testing, the total test time, Tts, is shown in equation 1.

$$Tts = {\sum }_{i = 1}^{4} Tc\_i + Ta\_i + Tp\_i \qquad ( 1 )$$

Also following the above four measurement test, for asynchronous testing, as illustrated in FIG. 2B, timeline 230, the total test time, Tta, is reduced by the minimum of the final RF measurement and the final non-RF measurement, as shown in equations 2 and 3.

$$\begin{matrix}Tta = ( {\sum }_{i = 1}^{2} Tta\_i ) + max ( Tta\_ 3 , Tta\_ 4 ) \\ where , & ( 2 ) \\ Tta\_i = Tc\_i + Ta\_i + Tp\_i & ( 3 )\end{matrix}$$

In either instance, during the measurement processing, Tp, the SA is not being utilized for acquisition and therefore, it has a utilization rate of less than 100%. Using the synchronous method, the utilization rate, U_s, can be expressed as shown in equation 4.

$$U\_s = \frac{{\sum }_{i = 1}^{n} Ta\_i}{{\sum }_{i = 1}^{n} Tc\_i + Ta\_i + Tp\_i} \qquad ( 4 )$$

Assuming that Tc<<Ta<Tp, equation 4 can be simplified to equation 5.

$$U\_s = \frac{{\sum }_{i = 1}^{n} Ta\_i}{{\sum }_{i = 1}^{n} Ta\_i + Tp\_i} \qquad ( 5 )$$

Hence, any method that decreases the processing time, Tp_i, during which the SA is idle, will increase the utilization of the SA.

### SUMMARY

Embodiments of the present invention relate to systems and associated methods for performing a test process. In one embodiment, a system for performing a test process may include one or more processors and a memory which may be coupled to the one or more processors, where the memory may store program instructions executable by the one or more processors to provide a test sequence, and more generally, to perform embodiments of the methods disclosed herein. The test sequence may include an acquisition sequence and a processing sequence. The acquisition sequence may include a sequence of acquisition functions for performing acquisitions on one or more units under test (UUTs), such as UE (User Equipment) devices, e.g., mobile wireless devices. The processing sequence may include a sequence of processing functions for processing measurement data resulting from the acquisitions. Each acquisition function of the acquisition sequence may be performed (in or by the method), including performing a plurality of acquisitions, thereby generating respective measurement data sets, and storing the respective measurement data sets in order of the acquisitions. Each processing function of the processing sequence may be performed, including processing the respective measurement data sets to analyze the one or more UUTs. Each respective measurement data set may be retrieved and processed in accordance with the order. In one embodiment, at least one processing function of the processing sequence may be performed concurrently with at least one acquisition function of the acquisition sequence. In another embodiment, all of the acquisition sequence functions may be completed prior to performance of any of the processing sequence functions.

In one embodiment, the storing of the respective measurement data sets may include enqueuing the respective measurement data sets into a queue data structure and the retrieving of the respective measurement data sets may include dequeuing the respective measurement data sets from the queue data structure.

In one embodiment, respective metadata may be generated for each of the respective measurement data sets and the respective metadata may be associated with each of the respective measurement data sets. In some embodiments, each respective measurement data set may be tagged with the respective metadata to associate the respective metadata and thereby generate respective tagged measurement data sets. Accordingly, the storing of the respective measurement data sets may include storing the respective tagged measurement data sets and the retrieving of the respective measurement data sets may include retrieving the respective tagged measurement data sets. In another embodiment, the storing of the respective tagged measurement data sets may include enqueuing the respective tagged measurement data sets into a queue data structure and the retrieving the respective tagged measurement data sets may include dequeuing the respective tagged measurement data sets from the queue data structure.

In further embodiments, the storing of the respective measurement data sets may include, for each measurement data set, storing the respective measurement data set in a respective memory location, and generating a reference to the respective measurement data set, where the reference indicates the respective memory location. The respective metadata may include the reference, and so instead of enqueuing the measurement data set itself, the respective metadata may be enqueued into a queue data structure. The retrieving of the respective measurement data set may thus include, for each respective measurement data set, dequeuing the metadata for the respective measurement data set from the queue data structure, and retrieving the respective measurement data set from the memory location based on the reference in the dequeued metadata.

Similarly, in one exemplary embodiment, storing of the respective measurement data sets may include, for each respective measurement data set, storing the respective measurement data set in a respective memory location, generating a reference to the respective measurement data set, where the reference indicates the respective memory location, and enqueuing the reference to the respective measurement data set into a queue data structure. The retrieving of the respective measurement data sets may include, for each respective measurement data set, dequeuing the reference to the respective measurement data set from the queue data structure, and retrieving the respective measurement data set from the respective memory location via the reference.

In one embodiment, the sequence of acquisition functions may include functions for configuring acquisition hardware for each of a plurality of acquisitions and functions for performing respective acquisitions of the plurality of acquisitions, thus generating the respective measurement data sets. In another embodiment, the functions for configuring the acquisition may include a function for configuring the acquisition hardware to perform a first acquisition of the plurality of acquisitions on a first UUT of the one or more UUTs and a function for configuring the acquisition hardware to perform a second acquisition of the plurality of acquisitions on the first UUT. In yet another embodiment, the functions for configuring acquisition hardware may include a function for configuring the acquisition hardware to perform a first acquisition of the plurality of acquisitions on a first UUT of the one or more UUTs and a function for configuring the acquisition hardware to perform a second acquisition of the plurality of acquisitions on a second UUT of the one or more UUTs.

In another embodiment, the acquisition sequence may include one or more RF tests and the processing sequence may include one or more RF processing functions. In an exemplary embodiment, the acquisition may also include one or more non-RF tests, where at least one acquisition function of the acquisition sequence of the one or more non-RF tests may be performed concurrently with at least one acquisition function of the acquisition sequence for the one or more RF tests. The processing sequence may also include one or more non-RF processing functions, where at least one of the one or more non-RF processing functions may be performed concurrently with at least one of the one or more RF processing functions. In yet another embodiment, the RF and non-RF test acquisition functions may be performed sequentially. Similarly, the RF and non-RF processing functions may be performed sequentially.

In some embodiments, the one or more UUTs may include a plurality of UUTs, where for at least two UUTs of the plurality of UUTs, acquisition functions of the acquisition sequence on each of the at least two UUTs may be performed concurrently, thereby generating respective data sets for the at least two UUTs concurrently. In further embodiments, the one or more processors may include a plurality of processors where for the at least two UUTs, respective processors of the plurality of processors may perform acquisition functions of the acquisition sequence on each of the at least two UUTs concurrently, thereby generating respective data sets for the at least two UUTs concurrently.

In one embodiment, at least one processing function of the processing sequence may be performed concurrently with at least one other processing function of the processing sequence. In another embodiment, all of the processing functions may be performed (concurrently and/or sequentially) after all of the acquisition sequence functions have been performed.

In yet another embodiment, the program instructions may include at least one graphical data flow program. Said another way, in some embodiments, the method may be implemented (at least partially) via at least one graphical data flow program. In another embodiment, programming instructions executable to perform any combination of the embodiments described herein may be stored in a computer accessible memory medium.

### BRIEF DESCRIPTION OF THE DRAWINGS

A better understanding of the present invention can be obtained when the following detailed description of the preferred embodiment is considered in conjunction with the following drawings, in which:

FIG. 1A illustrates a high level timeline for a synchronous test plan, according to the prior art;

FIG. 1B illustrates a high level timeline for an asynchronous test plan, according to the prior art;

FIG. 2A illustrates a detailed timeline for a synchronous test plan, according to the prior art;

FIG. 2B illustrates a detailed timeline for an asynchronous test plan, according to the prior art;

FIG. 3A illustrates a computer system, according to an embodiment of the invention;

FIG. 3B illustrates a network system, according to one embodiment;

FIG. 4A illustrates a test system, according to one embodiment;

FIG. 4B illustrates another system, according to one embodiment;

FIG. 5 illustrates an RF test system, according to one embodiment;

FIG. 6 illustrates a method for performing a test sequence, according to one embodiment;

FIG. 7 illustrates a method for performing a RF test sequence, according to one embodiment;

FIG. 8A illustrates a decoupled detailed timeline for a synchronous test plan, according to one embodiment;

FIG. 8B illustrates a decoupled detailed timeline for an asynchronous test plan, according to one embodiment;

FIG. 9A illustrates a decoupled detailed timeline for another asynchronous test plan, according to one embodiment; and

FIG. 9B illustrates a decoupled detailed timeline for yet anther asynchronous test plan, according to one embodiment.

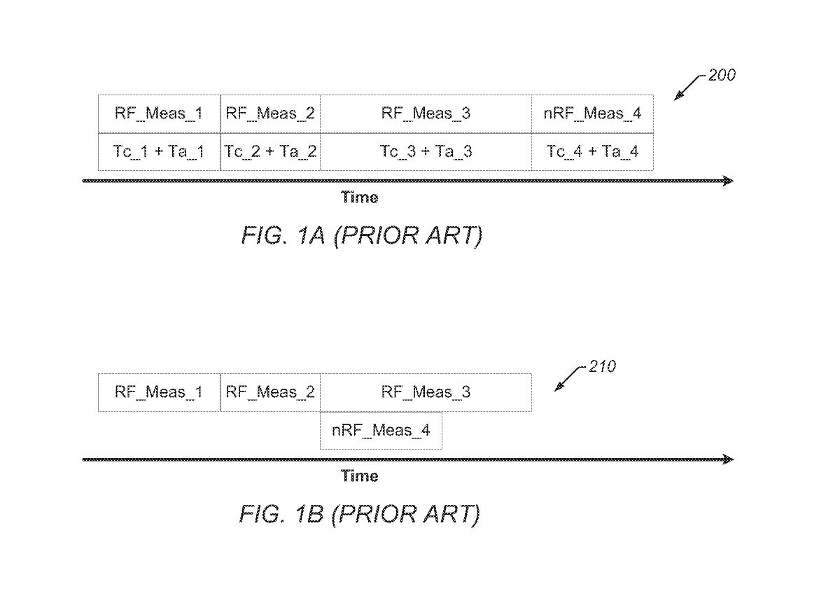

While the invention is susceptible to various modifications and alternative forms, specific embodiments thereof are shown by way of example in the drawings and are herein described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

### Definitions and Conventions

Unit Under Test (UUT)—A physical device or component that is being tested.

Memory Medium—Any of various types of memory devices or storage devices. The term “memory medium” is intended to include an installation medium, e.g., a CD-ROM, floppy disks 104, or tape device; a computer system memory or random access memory such as DRAM, DDR RAM, SRAM, EDO RAM, Rambus RAM, etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer which connects to the first computer over a network, such as the Internet. In the latter instance, the second computer may provide program instructions to the first computer for execution. The term “memory medium” may include two or more memory mediums which may reside in different locations, e.g., in different computers that are connected over a network.

Carrier Medium—a memory medium as described above, as well as signals such as electrical, electromagnetic, or digital signals, conveyed via a communication medium such as a bus, network and/or a wireless link.

Multiprocessor System—a computer system that includes multiple processing elements, i.e., processors, processing cores, or even networked computers, that may operate in a coordinated manner to execute program instructions concurrently.

Concurrently—a manner of performing actions or processes such that at least a portion of the (concurrent) processes overlap in time, e.g., at least one of the processes executes at least one iteration while another process executes an iteration. Concurrence, as used herein, may be accomplished in any of multiple ways, including through the use of single processor systems, e.g., via multi-threading, time-slices, etc., or multiprocessor (or multicore) systems, as well as any other technique for processing functions at the same time.

Function—a discrete set of one or more steps that form at least a part of a process.

Acquisition—refers to the acquiring of analog signals and converting the analog signals to digital data, e.g., bits.

Measurement Data Sets—the digital data resulting from an acquisition, including the “raw” digital bits and/or the digital bits converted via some scaling to any of a variety of formats, including voltages and other engineering units.

Programmable Hardware Element—includes various types of programmable hardware, reconfigurable hardware, programmable logic, or field-programmable devices (FPDs), such as one or more FPGAs (Field Programmable Gate Arrays), or one or more PLDs (Programmable Logic Devices), such as one or more Simple PLDs (SPLDs) or one or more Complex PLDs (CPLDs), or other types of programmable hardware. A programmable hardware element may also be referred to as “reconfigurable logic”.

Medium—includes one or more of a memory medium, carrier medium, and/or programmable hardware element; encompasses various types of mediums that can either store program instructions/data structures or can be configured with a hardware configuration program.

Program—the term “program” is intended to have the full breadth of its ordinary meaning. The term “program” includes 1) a software program which may be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that may be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program may comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, wherein the plurality of interconnected nodes or icons visually indicate functionality of the program.

Data Flow Graphical Program (or Data Flow Diagram)—A graphical program or diagram comprising a plurality of interconnected nodes, wherein the connections between the nodes indicate that data produced by one node is used by another node.

Graphical User Interface—this term is intended to have the full breadth of its ordinary meaning. The term “graphical user interface” is often abbreviated to “GUI”. A GUI may comprise only one or more input GUI elements, only one or more output GUI elements, or both input and output GUI elements.

The following provides examples of various aspects of GUIs. The following examples and discussion are not intended to limit the ordinary meaning of GUI, but rather provide examples of what the term “graphical user interface” encompasses:

A GUI may comprise a single window, panel, or dialog box having one or more GUI Elements, or may comprise a plurality of individual GUI Elements (or individual windows each having one or more GUI Elements), wherein the individual GUI Elements or windows may optionally be tiled together.

Graphical User Interface Element—an element of a graphical user interface, such as for providing input or displaying output. Exemplary graphical user interface elements include input controls and output indicators.

Input Control—a graphical user interface element for providing user input to a program. Exemplary input controls include buttons, check boxes, input text boxes, knobs, sliders, etc.

Output Indicator—a graphical user interface element for displaying output from a program. Exemplary output indicators include charts, graphs, gauges, output text boxes, numeric displays, etc. An output indicator is sometimes referred to as an “output control”.

Computer System—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Measurement Device—includes instruments, data acquisition devices, smart sensors, and any of various types of devices that are operable to acquire and/or store data from a UUT. A measurement device may also optionally be further operable to analyze or process the acquired or stored data. Examples of a measurement device include an instrument, such as a traditional stand-alone “box” instrument, a computer-based instrument (instrument on a card) or external instrument, a data acquisition card, a device external to a computer that operates similarly to a data acquisition card, a smart sensor, one or more DAQ or measurement cards or modules in a chassis, an image acquisition device, such as an image acquisition (or machine vision) card (also called a video capture board) or smart camera, a motion control device, a robot having machine vision, and other similar types of devices. Exemplary “stand-alone” instruments include oscilloscopes, multimeters, signal analyzers, arbitrary waveform generators, spectroscopes, and similar measurement, test, or automation instruments.

A measurement device may be further operable to perform control functions, e.g., in response to analysis of the acquired or stored data. For example, the measurement device may send a control signal to an external system, such as a motion control system or to a sensor, in response to particular data. A measurement device may also be operable to perform automation functions, i.e., may receive and analyze data, and issue automation control signals in response.

User Equipment (UE) (or “UE Device”)—any of various types of computer systems devices which are mobile or portable and which performs wireless communications, such as mobile wireless devices. Examples of UE devices include mobile telephones (e.g., cellular telephones (“cell phones”)) or smart phones (e.g., iPhone™, Android™-based phones), portable gaming devices (e.g., Nintendo DS™, PlayStation Portable™, Gameboy Advance™, iPod™), laptops, tablets (e.g., iPad™, Android™-based tablets), PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

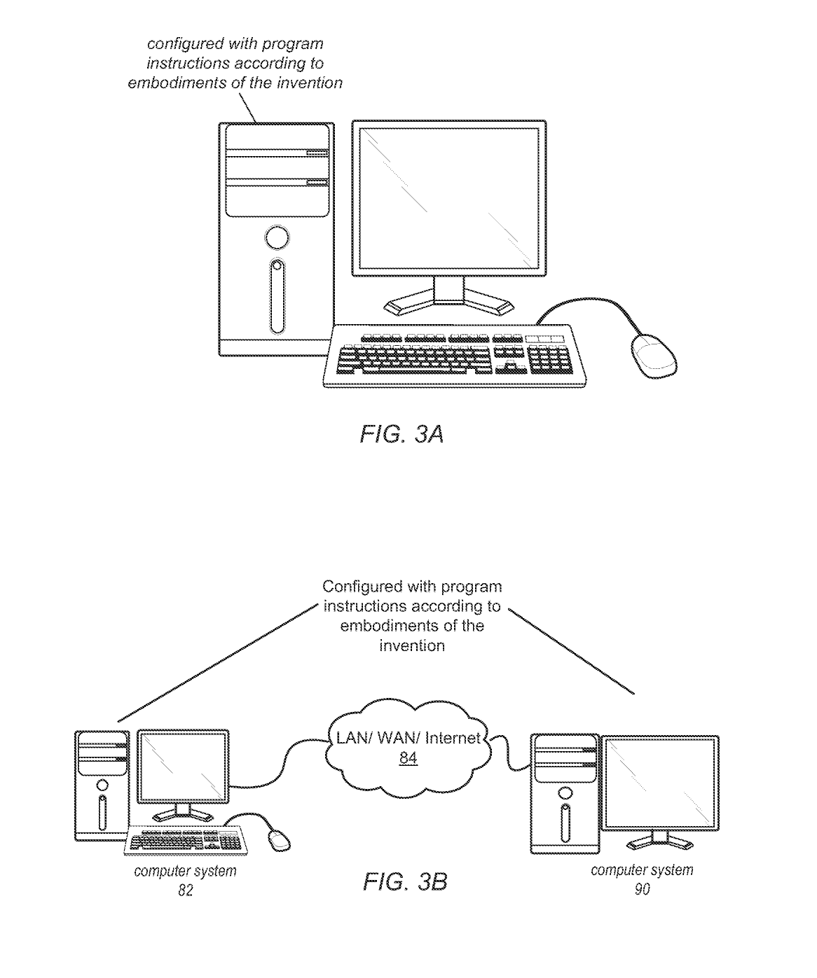

### FIG. 3A: Computer System

FIG. 3A illustrates a computer system 82 configured to implement embodiments of the present invention. More specifically, the computer system 82 may be configured to execute one or more programs, e.g., one or more graphical data flow programs, to execute a test sequence to test one or more units under test (UUTs), where the test sequence may include an acquisition sequence and a processing sequence, as described below in detail.

As shown in FIG. 3A, the computer system 82 may include a display device. In some embodiments, the computer system 82 may be configured to display the (possibly graphical) program as the program is created and/or executed. The display device may also be configured to display a graphical user interface or front panel of the program during execution of the program. The graphical user interface may comprise any type of graphical user interface, e.g., depending on the computing platform.

The computer system 82 may include at least one memory medium on which one or more computer programs or software components according to one embodiment of the present invention may be stored. The memory may be coupled to one or more processors and store program instructions executable by the one or more processors. For example, the memory medium may store one or more programs, e.g., graphical programs, which are executable to perform embodiments of the methods described herein. Additionally, the memory medium may store a programming development environment application used to create and/or execute such programs. The memory medium may also store operating system software, as well as other software for operation of the computer system. Various embodiments further include receiving or storing instructions and/or data implemented in accordance with the foregoing description upon a carrier medium.

### FIG. 3B: Computer Network

FIG. 3B illustrates a system including a first computer system 82 that is coupled to a second computer system 90. The computer system 82 may be coupled via a network 84 (or a computer bus) to the second computer system 90. The computer systems 82 and 90 may each be any of various types, as desired. The network 84 can also be any of various types, including a LAN (local area network), WAN (wide area network), the Internet, or an Intranet, among others. The computer systems 82 and 90 may execute programs, e.g., one or more graphical programs, in a distributed fashion. For example, computer 82 may execute a first portion of the block diagram of a graphical program and computer system 90 may execute a second portion of the block diagram of the graphical program. As another example, computer 82 may display the graphical user interface of a graphical program and computer system 90 may execute the block diagram of the graphical program.

In one embodiment, the graphical user interface of the program may be displayed on a display device of the computer system 82, and the block diagram may execute on a device coupled to the computer system 82. The device may include a programmable hardware element and/or may include a processor and memory medium which may execute a real time operating system. In one embodiment, the program may be downloaded and executed on the device. For example, an application development environment with which the program is associated may provide support for downloading a program for execution on the device in a real time system. It should be noted that while various embodiments are described herein in terms of a graphical program implementation, any other types of programs or programming technologies may be used as desired.

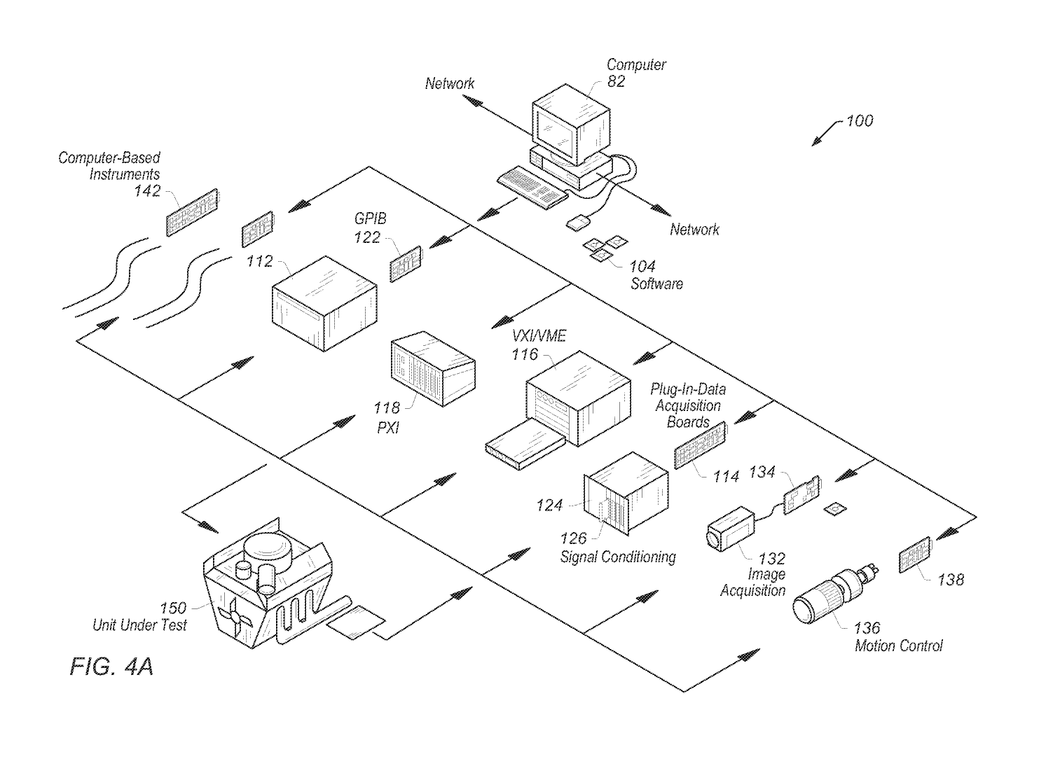

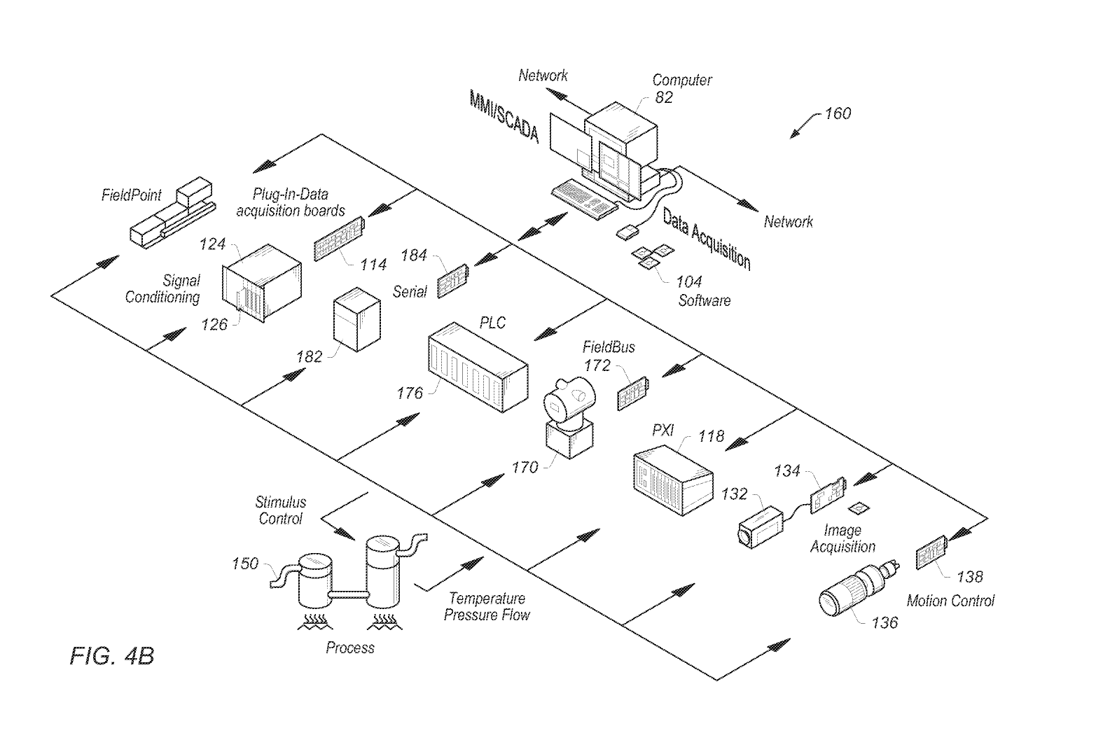

### FIGS. 4A-4B: Exemplary Systems

Embodiments of the present invention may be involved with performing test and/or measurement functions; controlling and/or modeling instrumentation or industrial automation hardware; modeling and simulation functions, e.g., modeling or simulating a device or product being developed or tested, etc. Exemplary test applications where the graphical program may be used include hardware-in-the-loop testing and rapid control prototyping, among others.

However, it is noted that embodiments of the present invention can be used for a plethora of applications and is not limited to the above applications. In other words, applications discussed in the present description are exemplary only, and embodiments of the present invention may be used in any of various types of systems. Thus, embodiments of the system and method of the present invention is configured to be used in any of various types of applications, including the control of other types of devices such as multimedia devices, video devices, audio devices, telephony devices, Internet devices, etc., as well as general purpose software applications such as word processing, spreadsheets, network control, network monitoring, financial applications, games, etc.

FIG. 4A illustrates an exemplary instrumentation control system 100 which may implement embodiments of the invention. The system 100 comprises a host computer 82 which couples to one or more instruments. The host computer 82 may comprise a CPU, a display screen, memory, and one or more input devices such as a mouse or keyboard as shown. The computer 82 may operate with the one or more instruments to analyze, measure, or control a unit under test (UUT) or process 150.

The one or more instruments may include a GPIB instrument 112 and associated GPIB interface card 122, a data acquisition board 114 inserted into or otherwise coupled with chassis 124 with associated signal conditioning circuitry 126, a VXI instrument 116, a PXI instrument 118, a video device or camera 132 and associated image acquisition (or machine vision) card 134, a motion control device 136 and associated motion control interface card 138, and/or one or more computer based instrument cards 142, among other types of devices. The computer system may couple to and operate with one or more of these instruments. The instruments may be coupled to the unit under test (UUT) or process 150, or may be coupled to receive field signals, typically generated by transducers. The system 100 may be used in a data acquisition and control application, in a test and measurement application, an image processing or machine vision application, a process control application, a man-machine interface application, a simulation application, or a hardware-in-the-loop validation application, among others.

FIG. 4B illustrates an exemplary industrial automation system 160 which may implement embodiments of the invention. The industrial automation system 160 may be similar to the instrumentation or test and measurement system 100 shown in FIG. 4A. Elements which are similar or identical to elements in FIG. 4A have the same reference numerals for convenience. The system 160 may comprise a computer 82 which couples to one or more devices or instruments. The computer 82 may comprise a CPU, a display screen, memory, and one or more input devices such as a mouse or keyboard as shown. The computer 82 may operate with the one or more devices to perform an automation function with respect to a process or device 150, such as MMI (Man Machine Interface), SCADA (Supervisory Control and Data Acquisition), portable or distributed data acquisition, process control, advanced analysis, or other control, among others.

The one or more devices may include a data acquisition board 114 inserted into or otherwise coupled with chassis 124 with associated signal conditioning circuitry 126, a PXI instrument 118, a video device 132 and associated image acquisition card 134, a motion control device 136 and associated motion control interface card 138, a fieldbus device 170 and associated fieldbus interface card 172, a PLC (Programmable Logic Controller) 176, a serial instrument 182 and associated serial interface card 184, or a distributed data acquisition system, such as the Fieldpoint system available from National Instruments, among other types of devices.

In the embodiments of FIGS. 4A and 4B above, one or more of the various devices may couple to each other over a network, such as the Internet. In one embodiment, the user operates to select a target device from a plurality of possible target devices for programming or configuration, e.g., using a graphical program. Thus the user may create a graphical program on a computer and use (execute) the graphical program on that computer or deploy the graphical program to a target device (for remote execution on the target device) that is remotely located from the computer and coupled to the computer through a network.

Graphical software programs which perform data acquisition, analysis and/or presentation, e.g., for measurement, instrumentation control, industrial automation, modeling, or simulation, such as in the applications shown in FIGS. 4A and 4B, may be referred to as virtual instruments (VIs).

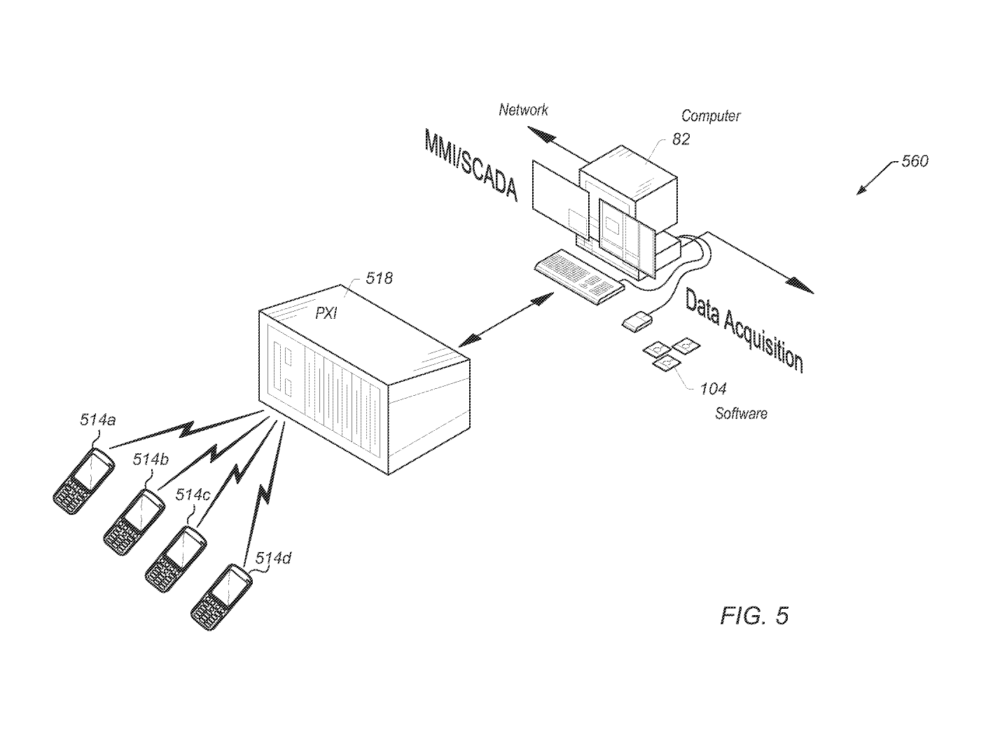

### FIG. 5: Exemplary RF System

FIG. 5 illustrates an exemplary RF test system 560 which may implement embodiments of the invention. The RF test system 560 may be similar to the instrumentation or test and measurement system 100 shown in FIG. 4A. It should be noted that the RF signals may be of any type, including, but not limited to, non-Orthogonal Frequency-Division Multiplexing (non-OFDM) cellular standards, such as Wideband Code Division Multiple Access (WCDMA), the Code Division Multiple Access 2000 family of standards (CDMA2K), and Global System for Mobile Communications—Enhanced Data rates for GSM Evolution (GSM-EDGE), and OFDM cellular standards such as, Long Term Evolution (LTE), Worldwide Interoperability for Microwave Access (WiMAX), and Wireless Local Area Network (WiLan). Elements which are similar or identical to elements in FIG. 4A have the same reference numerals for convenience.

The system 560 may include a computer 82 which couples to one or more devices or instruments. The computer 82 may include one or more processors, a display screen, memory coupled to the one or more processors, and one or more input devices such as a mouse or keyboard as shown. In one embodiment, the PXI chassis 518 may include one or more RF measurement cards, such as those made by National Instruments. The one or more RF measurement cards may include a memory coupled to one or more processors. Additionally, the chassis 518 may include a memory coupled to one or more processors. Further, the RF measurement cards may be configured to stimulate, or transmit signals to, one or more UUTs, such as user equipment (UE) devices 414a-414d and also receive signals from the one or more UUTs. In some embodiments, one or more signals from the one or more UUTs may be transmitted and received concurrently.

It should be noted that a UE device may be any of various types of computer systems devices which are mobile or portable and which performs wireless communications, such as mobile wireless devices. Examples of UE devices include mobile telephones (e.g., cellular telephones (“cell phones”) or smart phones, portable gaming devices, laptops, tablets, PDAs, portable Internet devices, music players, data storage devices, or other handheld devices, etc. In general, the term “UE” or “UE device” can be broadly defined to encompass any electronic, computing, and/or telecommunications device (or combination of devices) which is easily transported by a user and capable of wireless communication.

In one embodiment the system may include a memory, e.g., a non-transitory computer accessible memory medium, coupled to one or more processors, where the memory stores program instructions which may be executable by the one or more processors to implement embodiments of the testing method disclosed herein. For example, in one embodiment, the program instructions may be executable to provide a test sequence. The test sequence may include an acquisition sequence and a processing sequence. The acquisition sequence may include a sequence of acquisition functions for performing acquisitions on one or more UUTs, such as UE devices 514a-514d. The processing sequence may include a sequence of processing functions for processing measurement data resulting from the acquisitions.

In one embodiment, at least one processing function of the processing sequence may be performed concurrently with at least one acquisition function of the acquisition sequence. It should be noted that, as defined above, concurrently means that at least a portion of the (concurrent) processes overlap in time. Alternatively, in one embodiment the execution of the acquisition sequence and the processing sequence may be completely separate (temporally), where the acquisition sequence may be completed prior to any processing function being performed.

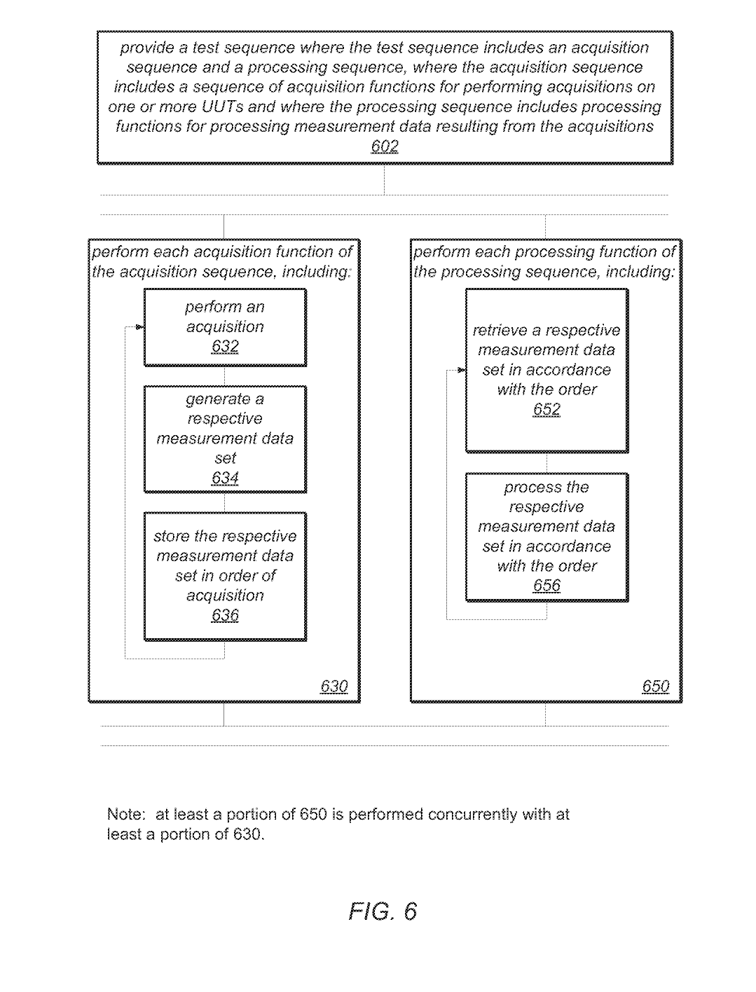

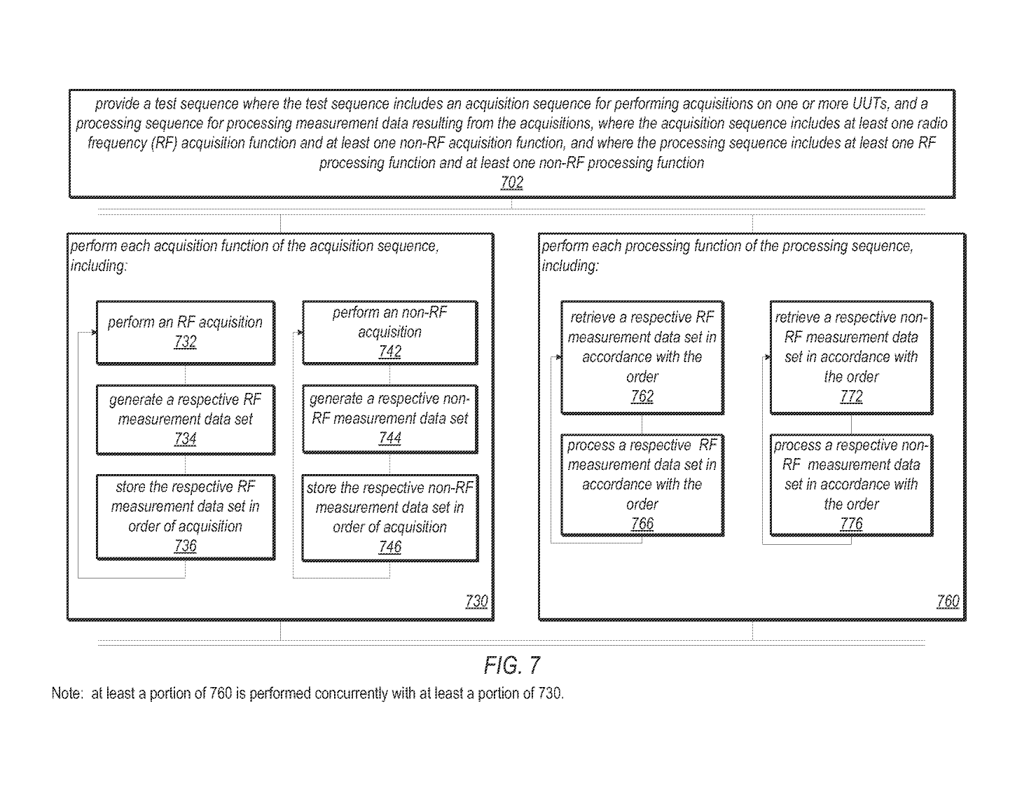

It should be noted that any of the system components described above may be used in any combination to perform embodiments of the methods illustrated in FIG. 6 and FIG. 7 and described in detail below.

### FIG. 6: Flowchart of a Method for Testing UUTs

FIG. 6 is a flowchart diagram of a method for implementing or performing a test process on UUTs. The method shown in FIG. 6 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 602, a test sequence may be provided, where the test sequence includes an acquisition sequence and a processing sequence. The acquisition sequence may include a sequence of acquisition functions for performing acquisitions on one or more UUTs. The processing sequence may include a sequence of processing functions for processing measurement data resulting from the acquisitions.

In 630, acquisition functions of the acquisition sequence may be performed. Performing an acquisition function may include performing an acquisition, as indicated in 632, generating a respective measurement data set, as indicated in 634, and storing the respective measurement data set in order of performance, as indicated in 636, i.e., in order of the acquisitions. In other words, the respective measurement data sets may be stored in the order in which they were acquired. Note that in some embodiments, performing an acquisition (632) produces raw data, which may be more useful in a different form. Accordingly, in some embodiments, generating the respective measurement data set (634) may include processing the raw data to a more useable or understandable form, e.g., the raw data may be scaled, smoothed, etc., as desired. As indicated by the arrow, the sequence of acquisition functions (632-636) may be repeated.

In 650, processing functions of the processing sequence may be performed. As FIG. 6 shows, performing processing functions may include retrieving a respective measurement data set in accordance with the order (of the acquisitions), as indicated in 652, and processing the respective measurement data set, also in accordance with the order, as indicated in 656. As indicated by the arrow, the sequence of processing functions (652-656) may be repeated.

As illustrated by the (horizontal) parallel lines of FIG. 6, in one embodiment, at least a portion of the sequence of processing functions of the processing sequence may be performed concurrently with at least a portion of the sequence of acquisition functions of the acquisition sequence.

In one embodiment, the storing of the respective measurement data set (636) may include enqueuing the respective measurement data sets in into a queue data structure and the retrieving each respective measurement data set (652) may include dequeuing the respective measurement data sets from the queue data structure.

In another embodiment, respective metadata for each of the respective measurement data sets may be generated and may be associated with the respective metadata with each of the respective measurement data sets. In one exemplary embodiment, in order to associate the respective metadata to the respective measurement data sets, each respective measurement data set may be tagged with the respective metadata, thereby generating respective tagged measurement data sets. Additionally, the storing of the respective measurement data sets (636) may include storing the tagged measurement data sets and the retrieving of the respective measurement data sets (656) may include retrieving the respective tagged measurement data sets. In some embodiments the storing of the respective tagged measurement data sets (636) may include enqueuing the respective tagged measurement data sets into a queue data structure and the retrieving of the respective tagged measurement data sets (656) may include dequeuing the respective tagged measurement data sets from the queue data structure.

In yet another embodiment, the storing of the respective measurement data sets (636) may include, for each respective measurement data set, storing the respective measurement data set in a respective memory location, generating a reference to the respective measurement data set where the reference indicates the respective memory location and where the respective metadata includes the reference, and enqueuing the respective metadata into a queue data structure. Accordingly, the retrieving of the respective measurement data set (656) may include, for each respective measurement data set, dequeuing the metadata for the respective measurement data set from the queue data structure and retrieving the respective measurement data set from the memory location based on the reference in the metadata.

In another embodiment, the storing the respective measurement data sets (636) may include, for each respective measurement data set, storing the respective measurement data set in a respective memory location, generating a reference to the respective measurement data set where the reference indicates the respective memory location, and enqueuing the reference to the respective measurement data set into a queue data structure. The retrieving of the respective measurement data set (656) may include, for each respective measurement data set, dequeuing the reference to the respective measurement data set from the queue data structure and retrieving the respective measurement data set from the respective memory location via the reference.

In one embodiment, regarding exemplary embodiments of the systems described above, e.g., per FIGS. 3A, 3B, 4A, 4B, and/or 5, the sequence of acquisition functions may include functions for configuring acquisition hardware for each of a plurality of acquisitions and functions for performing respective acquisitions of the plurality of acquisitions, thereby generating the respective measurement data sets. In another embodiment, the functions for configuring the acquisition hardware may include a function for configuring the acquisition hardware to perform a first acquisition of the plurality of acquisitions on a first UUT of the one or more UUTs and a function for configuring the acquisition hardware to perform a second acquisition of the plurality of acquisitions on the first UUT. In yet another embodiment, the functions for configuring acquisition hardware may include a function for configuring the acquisition hardware to perform a first acquisition of the plurality of acquisitions on a first UUT of the one or more UUTs, and a function for configuring the acquisition hardware to perform a second acquisition of the plurality of acquisitions on a second UUT of the one or more UUTs.

In another embodiment, also regarding exemplary embodiments of the systems disclosed herein, the one or more processors may include a plurality of processors, where one or more first processors of the plurality of processors may perform each acquisition function of the acquisition sequence, and where one or more second processors of the plurality of processors may perform each processing function of the processing sequence. In yet another embodiment, the one or more UUTs may include a plurality of UUTs, where for at least two UUTs of the plurality of UUTs, acquisition functions of the acquisition sequence performed on each of the at least two UUTs may be performed concurrently.

In an exemplary embodiment, for the at least two UUTs, respective processors of the plurality of processors may perform acquisition functions of the acquisition sequence on each of the at least two UUTs concurrently. In other words, for each UUT, there may be a processor performing acquisition functions of the acquisition sequence on the UUT.

In another embodiment, at least one processing function of the processing sequence may be performed concurrently with at least one other processing function of the processing sequence. In some embodiments, all of the processing functions of the processing sequence may be performed after the completion of all of the acquisition functions of the acquisition sequence. Note that the processing functions may be performed in the same order as the plurality of acquisitions, whether the processing functions are performed concurrently with at least a portion of the acquisition sequence or at some time after completion of the acquisition sequence. Of course, if the processing is performed after completion of the acquisition sequence, the order of processing may not matter.

In one exemplary embodiment one or more first processors of the plurality of processors may perform the acquisition functions (632-636) of the acquisition sequence. One or more second processors of the plurality of processors may perform the processing functions (652-656) of the processing sequence.

In another embodiment, also regarding exemplary embodiments of the systems disclosed herein, the test process may be an RF test process, where an RF test sequence may be provided. Similar to the above test sequence, the RF test sequence may include an RF acquisition sequence and an RF processing sequence. The RF acquisition sequence may include RF acquisition functions for performing acquisitions on one or more UUTs, where the one or more UUTs may include one or more mobile wireless devices. In another embodiment, the one or more UUTs may include one or more UE devices. The RF processing sequence may include a sequence of RF processing functions for processing measurement data resulting from the acquisitions. Each RF acquisition function of the RF acquisition sequence may be performed (in or by the method), including performing a plurality of RF acquisitions, thereby generating respective RF measurement data sets, and storing the respective RF measurement data sets in order of the RF acquisitions. Each RF processing function of the RF processing sequence may be performed, including processing the respective RF measurement data sets to analyze the one or more UUTs, which may include one or more mobile wireless devices. Each respective RF measurement data set may be retrieved and processed in accordance with the order. In one embodiment, at least one RF processing function of the RF processing sequence may be performed concurrently with at least one RF acquisition function of the RF acquisition sequence. In another embodiment, all of the RF acquisition sequence functions may be completed prior to performance of any of the RF processing sequence functions. Various further embodiments regarding RF testing are described below with reference to FIG. 7.

### FIG. 7: Flowchart of a Method for RF Testing on UUTs

FIG. 7 is a flowchart of a method for performing RF testing on UUTs, according to one embodiment. The method shown in FIG. 7 may be used in conjunction with any of the computer systems or devices shown in the above Figures, among other devices. In various embodiments, some of the method elements shown may be performed concurrently, in a different order than shown, or may be omitted. Additional method elements may also be performed as desired. As shown, this method may operate as follows.

In 702, a test sequence may be provided, where the test sequence may include an acquisition sequence for performing acquisitions on one or more UUTs, and a processing sequence for processing measurement data resulting from the acquisitions. The acquisition sequence may include at least one RF acquisition function and at least one non-RF acquisition function. The processing sequence may include at least one RF processing function and at least one non-RF processing function.

It should be noted that the RF signal may be, but is not limited to, any of the signals described above in reference to FIG. 5. Further, in certain embodiments, the one or more UUTs may include one or more UE devices, where a UE device can be broadly defined to encompass any electronic, computing, and/or telecommunications device (or combination of devices) which is easily transported by a user and capable of wireless communication. In some embodiments, the one or more UUTs may include one or more mobile wireless devices.

In 730, acquisition functions of the acquisition sequence may be performed. Performing an acquisition function may include performing a RF acquisition, as indicated in 732, generating a respective RF measurement data set, as indicated in 734, and storing the respective RF measurement data set in order of performance, as indicated in 736, i.e., in order of the RF acquisitions. Performing acquisition functions may further include performing a non-RF acquisition, as indicated in 742, generating a respective non-RF measurement data set, as indicated in 744, and storing the respective non-RF measurement data set in order of performance, as indicated in 746, i.e., in order of the acquisitions. In other words, the respective measurement data sets are stored in the order in which they were acquired. As noted above, in some embodiments, acquisitions (732 and 742) may produce raw data, which may be more useful in a different form. Accordingly, similar to the above, generating the respective measurement data sets (734 and 744) may include processing the raw data to a more useable or understandable form, e.g., the raw data may be scaled, smoothed, etc., as desired. As indicated by the arrow, the sequences of acquisition functions (732-736 and 742-746) may be repeated.

In 760, processing functions of the processing sequence may be performed. As FIG. 7 shows, performing processing functions may include retrieving a respective RF measurement data set in accordance with the order (of the RF acquisitions), as indicated in 762, and processing the respective RF measurement data set, also in accordance with the order, as indicated in 766. Performing processing functions may also include retrieving a respective non-RF measurement data set in accordance with the order (of the non-RF acquisitions), as indicated in 772, and processing the respective non-RF measurement data set, also in accordance with the order, as indicated in 776. As indicated by the arrow, the sequences of processing functions (762-766 and 772-776) may be repeated.

As illustrated by the (horizontal) parallel lines of FIG. 7, in one embodiment, at least a portion of the sequence of processing functions of the processing sequence may be performed concurrently with at least a portion of the sequence of acquisition functions of the acquisition sequence.

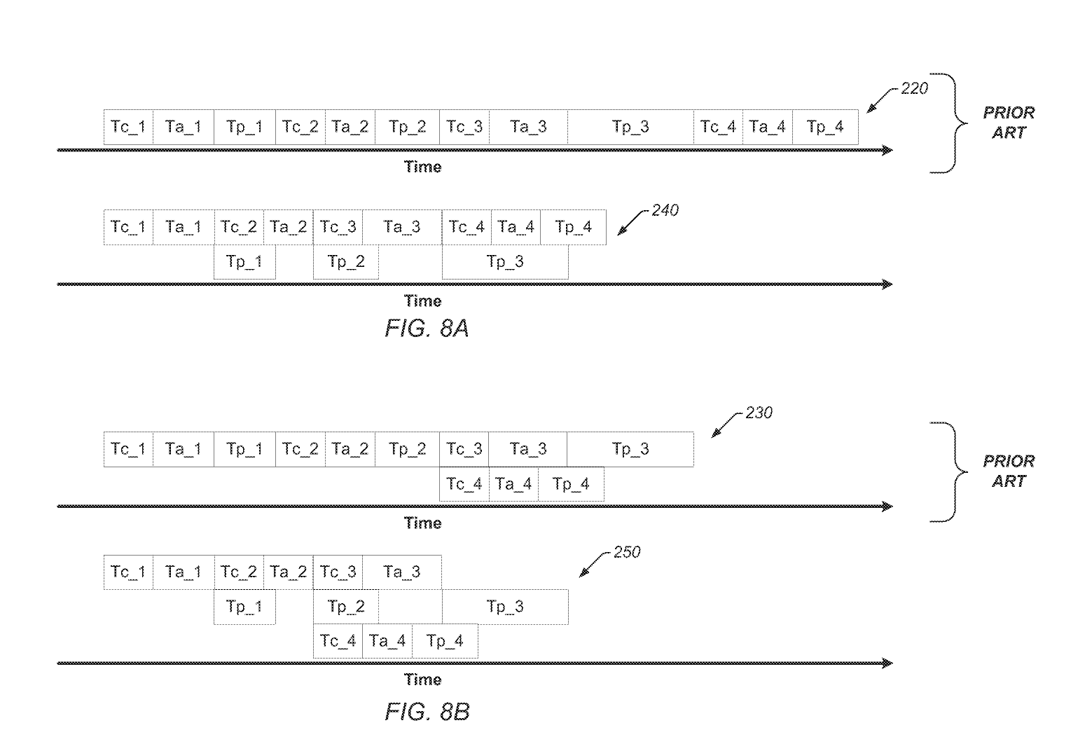

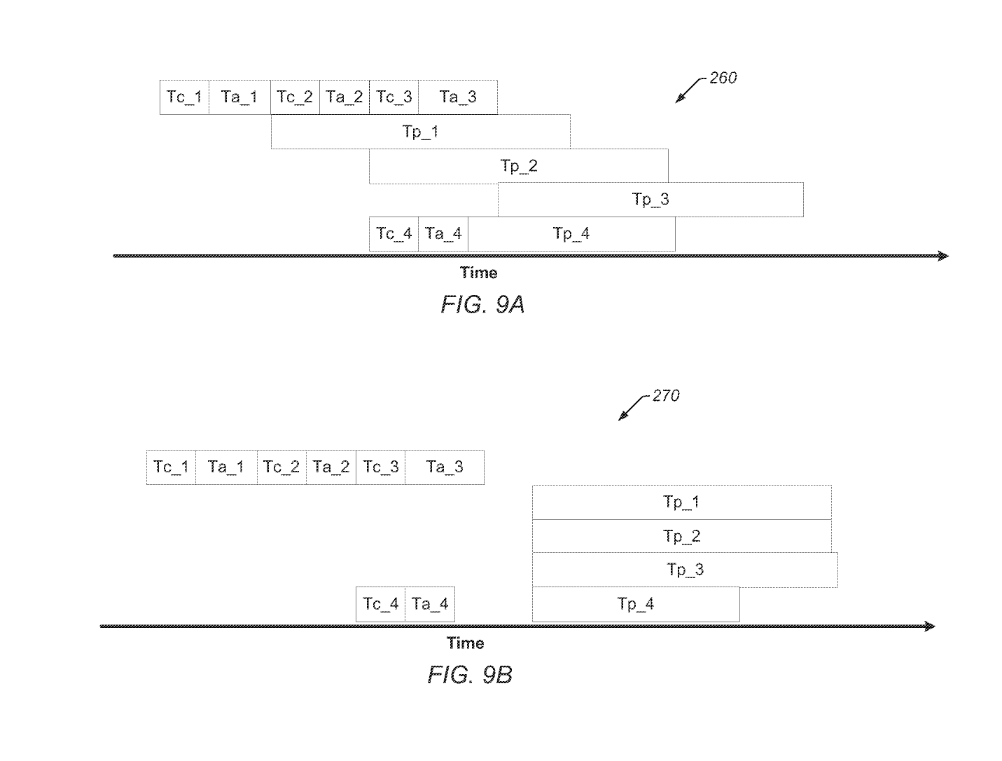

### FIGS. 8-9: Exemplary Timelines

As illustrated in FIGS. 8A-8B and FIGS. 9A-9B, the concurrence (of acquisitions and processing) may occur in any of multiple ways.

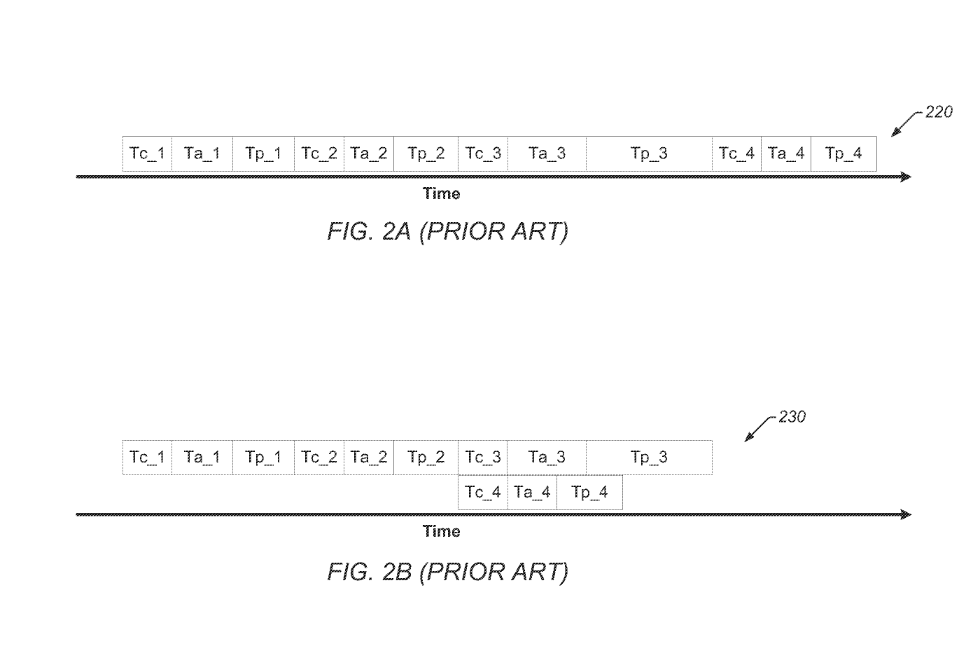

FIG. 8A, for example, illustrates one embodiment, where, as illustrated by exemplary timeline 240, shown along with prior art synchronous timeline 220 (per FIG. 2A), test time may be decreased by decoupling the acquisition sequence from the processing sequence, via embodiments of the method depicted in FIG. 6 and described above. Note, for example, that in timeline 240, that at least portions of processing function Tp_1 may be performed concurrently with at least portions of acquisition function Tc_2.

FIG. 8B is illustrative of another embodiment, where, as illustrated by exemplary timeline 250, shown along with prior art asynchronous timeline 230 (per FIG. 2B), the test time may be further decreased by further decoupling acquisition functions within the acquisition sequence, using for example, embodiments of the method depicted in FIG. 7 and described above. Note, for example, that in timeline 250, at least portions of acquisition functions Tc_3 and Tc_4 may be performed concurrently with at least portions of processing function Tp_2.

FIG. 9A is illustrative of yet another exemplary embodiment, where, as illustrated by exemplary timeline 260, multiple processing functions of the processing sequence are performed concurrently with (a portion of) the acquisition sequence to decrease test time, via decoupling of the processing sequence from the acquisition sequence. Note for example, that in timeline 260, at least portions of acquisition functions Tc_3 and Tc_4 may be performed concurrently with at least portions of processing functions Tp_1 and Tp_2. Additionally, at least portions of processing functions Tp_2 and Tp_3 may be performed concurrently.

FIG. 9B is illustrative of a further embodiment, where, as illustrated by exemplary timeline 270, the processing sequence may not be performed until all of the acquisition sequence has been performed. It should be noted, that while timeline 270 illustrates performance of multiple processing functions of the processing sequence occurring concurrently (for example, at least portions of Tp_1, Tp_2, Tp_3, and Tp_4 may be performed concurrently), it is also envisioned that the processing functions may be performed sequentially in accordance with the order of the acquisition sequence, or, alternatively, the processing functions may be performed in some other optimized order to further reduce processing time and/or increase processor utilization.

It should be noted that while specific embodiments have been described and disclosed herein, it is intended that any features of any embodiments described herein may be combined or used together as desired, and further, may be implemented via any embodiments of the systems disclosed herein, or variants thereof.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A system for a test process, the system comprising:
one or more processors; and
a memory, coupled to the one or more processors, wherein the memory stores program instructions executable by the one or more processors to:
provide a test sequence, wherein the test sequence comprises:
an acquisition sequence, comprising a sequence of acquisition functions for performing acquisitions on one or more units under test (UUTs); and
a processing sequence, comprising a sequence of processing functions for processing measurement data resulting from the acquisitions;
perform each acquisition function of the acquisition sequence, including performing a plurality of acquisitions, thereby generating respective measurement data sets, and storing the respective measurement data sets in order of said performing the plurality of acquisitions; and
perform each processing function of the processing sequence, including processing the respective measurement data sets to analyze the one or more UUTs, including retrieving and processing each respective measurement data set in accordance with the order;
wherein at least one processing function of the processing sequence is performed concurrently with at least one acquisition function of the acquisition sequence.

2. The system of claim 1,
wherein said storing the respective measurement data sets comprises enqueuing the respective measurement data sets into a queue data structure; and
wherein said retrieving comprises dequeuing the respective measurement data sets from the queue data structure.

3. The system of claim 1, wherein the program instructions are further executable to:
generate respective metadata for each of the respective measurement data sets; and
associate the respective metadata with each of the respective measurement data sets.

4. The system of claim 3, wherein to associate the respective metadata, the program instructions are executable to:
tag each respective measurement data set with the respective metadata, thereby generating respective tagged measurement data sets;
wherein said storing respective measurement data sets comprises storing the respective tagged measurement data sets; and
wherein said retrieving comprises retrieving the respective tagged measurement data sets.

5. The system of claim 4,
wherein said storing respective tagged measurement data sets comprises enqueuing the respective tagged measurement data sets into a queue data structure; and
wherein said retrieving the respective tagged measurement data sets comprises dequeuing the respective tagged measurement data sets from the queue data structure.

6. The system of claim 3, wherein said storing respective measurement data sets comprises:
for each respective measurement data set:
storing the respective measurement data set in a respective memory location;
generating a reference to the respective measurement data set, wherein the reference indicates the respective memory location, and wherein the respective metadata includes the reference; and
enqueuing the respective metadata into a queue data structure; and
wherein said retrieving respective measurement data sets comprises:
for each respective measurement data set:
dequeuing the metadata for the respective measurement data set from the queue data structure; and
retrieving the respective measurement data set from the memory location based on the reference in the metadata.

7. The system of claim 1, wherein said storing the respective measurement data sets comprises:
for each respective measurement data set:
storing the respective measurement data set in a respective memory location;
generating a reference to the respective measurement data set, wherein the reference indicates the respective memory location; and
enqueuing the reference to the respective measurement data set into a queue data structure; and
wherein said retrieving the respective measurement data sets comprises:
for each respective measurement data set:
dequeuing the reference to the respective measurement data set from the queue data structure; and
retrieving the respective measurement data set from the respective memory location via the reference.

8. The system of claim 1, wherein the sequence of acquisition functions comprises:
functions for configuring acquisition hardware for each of a plurality of acquisitions; and
functions for performing respective acquisitions of the plurality of acquisitions, thereby generating the respective measurement data sets.

9. The system of claim 8, wherein the functions for configuring acquisition hardware comprise:
a function for configuring the acquisition hardware to perform a first acquisition of the plurality of acquisitions on a first UUT of the one or more UUTs; and
a function for configuring the acquisition hardware to perform a second acquisition of the plurality of acquisitions on the first UUT.

10. The system of claim 8, wherein the one or more UUTs comprise a plurality of UUTs, and wherein the functions for configuring acquisition hardware comprise:
a function for configuring the acquisition hardware to perform a first acquisition of the plurality of acquisitions on a first UUT of the plurality of UUTs; and
a function for configuring the acquisition hardware to perform a second acquisition of the plurality of acquisitions on a second UUT of the plurality of UUTs.

11. The system of claim 1,
wherein the acquisition sequence comprises one or more radio frequency (RF) acquisition functions; and
wherein the processing sequence comprises one or more RF processing functions.

12. The system of claim 11, wherein the acquisition sequence further comprises one or more non-RF acquisition functions;
wherein at least one of the one or more non-RF acquisition functions is performed concurrently with at least one of the one or more RF acquisition functions;
wherein the processing sequence further comprises one or more non-RF processing functions; and
wherein at least one of the one or more non-RF processing functions is performed concurrently with at least one of the one or more RF processing functions.

13. The system of claim 1,
wherein the one or more processors comprise a plurality of processors;
wherein one or more first processors of the plurality of processors perform each acquisition function of the acquisition sequence; and
wherein one or more second processors of the plurality of processors perform each processing function of the processing sequence.

14. The system of claim 1,
wherein the one or more UUTs comprise a plurality of UUTs; and
wherein for at least two UUTs of the plurality of UUTs, acquisition functions of the acquisition sequence on each of the at least two UUTs are performed concurrently, thereby generating respective data sets for the at least two UUTs concurrently.

15. The system of claim 14,
wherein the one or more processors comprise a plurality of processors; and
wherein for the at least two UUTs, respective processors of the plurality of processors perform acquisition functions of the acquisition sequence on each of the at least two UUTs concurrently, thereby generating respective data sets for the at least two UUTs concurrently.

16. The system of claim 1,
wherein at least one processing function of the processing sequence is performed concurrently with at least one other processing function of the processing sequence.

17. The system of claim 1,
wherein the program instructions comprise at least one graphical data flow program.

18. A non-transitory computer accessible memory medium that stores program instructions executable by one or more processors to perform:
providing a test sequence, wherein the test sequence comprises:
an acquisition sequence, comprising a sequence of acquisition functions for performing acquisitions on one or more units under test (UUTs); and
a processing sequence, comprising a sequence of processing functions for processing measurement data resulting from the acquisitions;
performing each acquisition function of the acquisition sequence, including performing a plurality of acquisitions, thereby generating respective measurement data sets, and storing the respective measurement data sets in order of said performing the plurality of acquisitions; and
performing each processing function of the processing sequence, including processing the respective measurement data sets to analyze the one or more UUTs, including retrieving and processing each respective measurement data set in accordance with the order;
wherein at least one processing function of the processing sequence is performed concurrently with at least one acquisition function of the acquisition sequence.

19. The non-transitory computer accessible memory medium of claim 18,
wherein said storing the respective measurement data sets comprises enqueuing the respective measurement data sets into a queue data structure; and
wherein said retrieving comprises dequeuing the respective measurement data sets from the queue data structure.

20. The non-transitory computer accessible memory medium of claim 18, further comprising:
generating respective metadata for each of the respective measurement data sets; and
associating the respective metadata with each of the respective measurement data sets;
wherein said associating comprises tagging each respective measurement data set with the respective metadata, thereby generating respective tagged measurement data sets;
wherein said storing respective measurement data sets comprises storing the respective tagged measurement data sets, wherein said storing respective tagged measurement data sets comprises enqueuing the respective tagged measurement data sets into a queue data structure; and
wherein said retrieving comprises retrieving the respective tagged measurement data sets, wherein said retrieving the respective tagged measurement data sets comprises dequeuing the respective tagged measurement data sets from the queue data structure.

21. The non-transitory computer accessible memory medium of claim 18, further comprising:
generating respective metadata for each of the respective measurement data sets; and
associating the respective metadata with each of the respective measurement data sets;
wherein said storing respective measurement data sets comprises:
for each respective measurement data set:
storing the respective measurement data set in a respective memory location;
generating a reference to the respective measurement data set, wherein the reference indicates the respective memory location, and wherein the respective metadata includes the reference; and
enqueuing the respective metadata into a queue data structure; and
wherein said retrieving respective measurement data sets comprises:
for each respective measurement data set:
dequeuing the metadata for the respective measurement data set from the queue data structure; and
retrieving the respective measurement data set from the memory location based on the reference in the metadata.

22. The non-transitory computer accessible memory medium claim 18, wherein said storing the respective measurement data sets comprises:
for each respective measurement data set:
storing the respective measurement data set in a respective memory location;
generating a reference to the respective measurement data set, wherein the reference indicates the respective memory location; and
enqueuing the reference to the respective measurement data set into a queue data structure; and
wherein said retrieving the respective measurement data sets comprises:
for each respective measurement data set:
dequeuing the reference to the respective measurement data set from the queue data structure; and
retrieving the respective measurement data set from the respective memory location via the reference.

23. The non-transitory computer accessible memory medium of claim 18, wherein the sequence of acquisition functions comprises:
functions for configuring acquisition hardware for each of a plurality of acquisitions; and
functions for performing respective acquisitions of the plurality of acquisitions, thereby generating the respective measurement data sets.

24. The non-transitory computer accessible memory medium of claim 23, wherein the functions for configuring acquisition hardware comprise:
a function for configuring the acquisition hardware to perform a first acquisition of the plurality of acquisitions on a first UUT of the one or more UUTs; and
a function for configuring the acquisition hardware to perform a second acquisition of the plurality of acquisitions on the first UUT.

25. The non-transitory computer accessible memory medium of claim 23, wherein the one or more UUTs comprise a plurality of UUTs, and wherein the functions for configuring acquisition hardware comprise:
a function for configuring the acquisition hardware to perform a first acquisition of the plurality of acquisitions on a first UUT of the plurality of UUTs; and
a function for configuring the acquisition hardware to perform a second acquisition of the plurality of acquisitions on a second UUT of the plurality of UUTs.

26. The non-transitory computer accessible memory medium of claim 18,
wherein the acquisition sequence comprises one or more radio frequency (RF) acquisition functions; and
wherein the processing sequence comprises one or more RF processing functions.

27. The non-transitory computer accessible memory medium of claim 26, wherein the acquisition sequence further comprises one or more non-RF acquisition functions;
wherein at least one of the one or more non-RF acquisition functions is performed concurrently with at least one of the one or more RF acquisition functions;
wherein the processing sequence further comprises one or more non-RF processing functions; and
wherein at least one of the one or more non-RF processing functions is performed concurrently with at least one of the one or more RF processing functions.

28. A computer-implemented method implementing a test process, the method comprising:
utilizing a computer to perform:
providing a test sequence, wherein the test sequence comprises:
an acquisition sequence, comprising a sequence of acquisition functions for performing acquisitions on one or more units under test (UUTs); and
a processing sequence, comprising a sequence of processing functions for processing measurement data resulting from the acquisitions;
performing each acquisition function of the acquisition sequence, including performing a plurality of acquisitions, thereby generating respective measurement data sets, and storing the respective measurement data sets in order of said performing the plurality of acquisitions; and
performing each processing function of the processing sequence, including processing the respective measurement data sets to analyze the one or more UUTs, including retrieving and processing each respective measurement data set in accordance with the order;
wherein at least one processing function of the processing sequence is performed concurrently with at least one acquisition function of the acquisition sequence.

29. A system for a RF test process, the system comprising:
one or more processors; and
a memory, coupled to the one or more processors, wherein the memory stores program instructions executable by the one or more processors to:
provide a RF test sequence, wherein the RF test sequence comprises:
an RF acquisition sequence, comprising a sequence of RF acquisition functions for performing acquisitions on one or more units under test (UUTs), wherein the one or more UUTs comprise one or more mobile wireless devices; and
an RF processing sequence, comprising a sequence of RF processing functions for processing measurement data resulting from the acquisitions;
perform each RF acquisition function of the RF acquisition sequence, including performing a plurality of RF acquisitions, thereby generating respective RF measurement data sets, and storing the respective RF measurement data sets in order of said performing the plurality of RF acquisitions; and
perform each RF processing function of the RF processing sequence, including processing the respective RF measurement data sets to analyze the one or more UUTs, including retrieving and processing each respective RF measurement data set in accordance with the order;
wherein at least one RF processing function of the RF processing sequence is performed concurrently with at least one RF acquisition function of the RF acquisition sequence.
